(19) United States
(12) Patent Application Publication
(10) Pub. No.: US 2024/0137367 A1
(43) Pub. Date: Apr. 25, 2024

(54) PROFILE PROVISIONING PLATFORM

(71) Applicant: Giesecke+Devrient ePayments GmbH, Munich (DE)

(72) Inventors: Waleed BADAWY, Munchen (DE); Nirmalkumar Vasant PATEL, Pune (IN); Frank KORBER, Olching (DE); David RUIZ LITWINSKI, Huddinge (SE)

(21) Appl. No.: 18/490,994

(22) Filed: Oct. 19, 2023

(30) Foreign Application Priority Data
Oct. 23, 2022 (EP) 22020511.6

(51) Int. Cl. H04L 9/40; H04L 67/306; H04W 8/18; H04W 12/30

(52) U.S. Cl. CPC H04L 63/102; H04L 67/306; H04W 8/18; H04W 12/30

(57) ABSTRACT

A profile provisioning platform, includes a profile database which allows access by at least two different profile providers or/and at least two different use case owners or/and at least two different UICC requesters; and which includes a business relation manager managing access of the different profile providers, use case owners and UICC requesters to data in the profile database.

### FIELD OF THE INVENTION

The present invention relates to a profile provisioning platform, and to methods for provisioning data to said platform, and for operating said platform.

### BACKGROUND OF THE INVENTION AND PRIOR ART

Mobile devices, being devices able to communicate in a mobile network, are known in use cases covering the M2M sector, particularly the Automotive an industrial sectors, and the Consumer sector. A mobile device includes a Universal Integrated Circuit Card, UICC, including one or several profiles, each profile owned by a Mobile Network Operator, MNO, and assigned to a mobile device owner and to a mobile network, and including authentication information for authenticating the mobile device owner versus the mobile network of the MNO. The MNO usually has agreements with other MNOs, allowing the mobile device user the usage also of other mobile networks under defined conditions.

For an UICC, different form factors are known, for example a Plug-In SIM card, a soldered in embedded UICC, eUICC, or an all-Software eSIM or an integrated iUICC implemented in a chip of the mobile device. Thus, UICC can be for example a SIM card, an eUICC, an iUICC or an eSIM.

Up-to-date UICCs allow the provisioning of profiles in the UICC from a profile provisioning platform operated by a profile manufacturer. The provisioning can include for example loading and installing profiles from the profile provisioning platform to the UICC, amending already present profiles and deleting profiles, amending a status of present profiles, for example enabling and disabling profiles.

Profile provisioning platforms are described in the GSMA specifications SGP.02 and SGP.22, particularly versions [1] SGP.02-v4.2, Remote Provisioning Architecture for Embedded UICC Technical Specification, Version 4.2, 7 Jul. 2020, and [2] SGP.22-v2.2.2, SGP.22 RSP Technical Specification, Version 2.2.2, 5 Jun. 2020.

The provisioning platform disclosed in [1] SGP.02-v4.2, aiming particularly at M2M use cases such as Automotive and industrial use cases, comprises a profile preparation server SM-DP, Subscription-Manager Data-Preparation, and a profile provisioning server SM-SR, Subscription-Manager Secure-Router. The provisioning platform disclosed in [2] SGP.22-v2.2.2, aiming particularly at Consumer devices such as smartphones and the like, comprises a profile server SM-DP+, Subscription-Manager Data-Preparation-Plus, combining in itself the functions of a profile preparation server SM-DP and a profile provisioning server SM-SR. Thus, mention of a profile preparation server can be directed to for example either an SG.02 SM-DP (M2M use cases) or a SGP.22 SM-DP+ (Consumer use cases), in both cases addressing the data preparation functionality.

The profile preparation server SM-DP or SM-DP+ includes or cooperates with a data generation instance IDSP operated by the profile manufacturer operating the profile preparation server. The data generation instance IDSP receives profile data provided by a profile provider, for example a mobile network operator MNO, and processes the provided profile data and further data so as to contribute to generating a profile that can be installed to a UICC. The output of the data generation instance IDSP is personalization data that, when installed in a UICC, install in the UICC a profile with the profile data that was provided from the profile provider.

The profile data is an individual set of data of a particular profile required for later usage of the profile in its destined to purpose of authentication in the target mobile network. The profile data include as three important elements an International Mobile Subscriber Identity IMSI and an authentication key Ki, profile number ICCID (the abbreviation stands for Integrated Circuit Card Identifier, since historically a UICC card contained only one profile, so the profile was logically identical to the physical UICC card), all usually provided by the MNO of the target mobile network.

A data set which is also described in for example [1] SGP.02 is the so called eUICC Information Set, or briefly EIS, which is a set of eUICC information data or eUICC metadata. The EIS according to [1] SGP.02 contains, for example, information about which profiles are installed in an eUICC and about the status of the profiles, particularly which profile is or are active or enabled, and which profile is or are disabled, communication keys for communication over the ES5 interface, and others.

When a data generation instance IDSP according to [1] SGP.02 generates, from profile data, a profile for a target eUICC, it also retrieves from the target eUICC the EIS. The profile and the EIS are stored to the SM-DP. When the profile shall be downloaded to the eUICC, the profile is transferred from the SM-DP to the SM-SR and downloaded from the SM-SR to the eUICC.

Profile provisioning, so as to provide profiles to UICCs, includes three roles, namely, first, a profile provider which provides profile data destined for generation of a profile, second, a UICC requester which requests, by a UICC order, a UICC and, by a profile order, requests one or several profiles to be installed in the UICC, and, third, a use case owner who provides a framework for hosting the UICC with the one or several profiles. In the setup of the profile provisioning platform according to [1] SGP.02, as visible from FIG. 1, the profile provider interface is provided by interface ES4. A UICC requester is provided with downloaded profiles by interface ES5.

In an M2M Automotive environment, the profile provider can be an MNO, herein a real MNO or a virtual MNO, MVNO. The UICC requester can be a manufacturer or provider of an Automotive mobile device included in the car, the Automotive mobile device hosting a UICC. The use case owner can be the car manufacturer providing the car with the Automotive mobile device.

In a consumer environment, the profile provider can be an MNO, which can be a real MNO or an MVNO, the UICC requester can be a UICC manufacturer, and the use case owner can be a smartphone manufacturer.

In the classical current profile provisioning landscape, a profile provisioning platform is fixedly assigned to a particular set of a profile provider, e.g. MNO, (Role 1) UICC requester (Role 2) and use case owner (Role 3).

The profile provider is the owner of profiles in the profile provisioning platform. Many pieces of information required for ordering a profile for a use case of a use case owner and downloading the ordered profile to a target UICC require exchange of information on the profile and the UICC, for example ICCID of the profile, or EID of the UICC.

A typical use case of a mobile device in an Automotive environment is an Automotive mobile device included in a car of a carmaker. The Automotive mobile device includes a UICC including at least one profile owned by a particular MNO. The profile enables the Automotive mobile device to communicate in the mobile network of the MNO owning the profile. For provisioning profiles to and in the UICC of the Automotive mobile device, a profile provisioning platform including a profile preparation server SM-DP, the SM-DP including or cooperating with a data generation instance IDSP, and a Secure Router SM-SR is used. The request to download a profile to the UICC can be made by the MNO (profile provider), or by the carmaker (use case owner).

A different carmaker makes use of a different profile provisioning platform, also including the full set of profile preparation server SM-DP, including or cooperating with a data generation instance IDSP, and a Secure Router SM-SR, even if the MNO is the same.

From the view of a Mobile Network Operator, MNO, similar profiles are provided to different carmakers, herein making use of a separate profile provisioning platform for each carmaker, even though some elements of the separate profile provisioning platform might be similar in each of the separate platforms.

In case an MNO intends to cooperate with a new carmaker, an entire new profile provisioning platform has to be set up, resulting in high costs and a long time-to-market when adding new cooperation partners to a profile provisioning infrastructure. In addition, every new setting up of a profile provisioning platform is prone to errors, as compared to continuing operation of an established profile provisioning platform. Also, having to maintain a large number of distinct profile provisioning platforms increases the risk that errors occur during operation and/or on the occasion of maintenance.

The document [3] WO2019067244A1 from the prior art discloses an eSIM management framework of an MNO managing several distinct profile preparation platforms of several distinct UICC manufacturers, EUMs. The eSIM management framework of the MNO has access to all of the several distinct profile preparation platforms, and to several use case owners, called Partners.

### OBJECTIVE OF THE INVENTION

It is an object of the present invention to provide a profile preparation platform that can support to reduce complexity, avoid errors in setup, operation and/or maintenance, and that can support to reduce costs and time-to-market.

### SUMMARY OF THE INVENTION

The object of the invention is achieved by a profile preparation platform with the following features, according to claim 1. Embodiments of the invention are presented in dependent claims.

The profile provisioning platform comprises:
a profile database storing data related to a profile for an UICC;
at least one profile provider interface allowing a profile provider to exchange data with the profile database;
at least one-use case owner interface allowing a use case owner to exchange data with the profile database;
at least one UICC requester interface allowing a UICC requester to exchange data with the profile database, said exchange including at least to request profiles and receive profiles from the profile database;
characterized by:
a business relation manager managing access of the different profile providers, use case owners and UICC requesters to data in the profile database based on access rules related to the data.

The business relation manager allows to grant access to the profile provisioning platform by all three roles of the profile provider, the use case owner and the UICC requester, without requiring exchange of required information via alternative channels, like mailings or the like outside the profile provisioning platform.

By this, the complexity of operating the profile provisioning platform is reduced, which can help to avoid errors in setup, operation and/or maintenance, and can support to reduce costs and time-to-market of the platform and updates to it.

According to embodiments, the profile database allows access by at least two different profile providers or/and at least two different use case owners or/and at least two different UICC requesters.

By allowing access to data in the profile database by different profile providers, use case owners and UICC requesters under management of the business relation manager, similar elements or pieces of data contained in the data of the database have to be provided only once by some party, e.g. a profile provider, use case owner or UICC requester, and can be used in a shared way by all parties having access rights to said element or piece of data. The access rules herein ensure a controlled access to the data.

By this, a smaller number of overall elements or pieces of data is provided as compared to providing a separate full profile provisioning platform for every combination of different profile providers, use case owners and UICC requesters.

By this, the size and complexity are reduced, and thus the risk of errors occurring during operation and maintenance of the profile provisioning platform is reduced. In addition the effort, risk of failure, costs and time-to-market when adding new different profile providers, use case owners or UICC requesters are reduced.

According to some embodiments, the business relation manager applies, as a type of access rules, a set of business relation governance rules so as to allow or disallow access of certain profile providers, use case owners and UICC requesters to data in the profile database, particularly access to data provided by a party, namely profile provider, use case owner or UICC requester, different from the accessing party, namely profile provider, use case owner or UICC requester.

The business relation governance rules can for example include the following.

A business relation governance rules can be or imply a rule that ensures that a data requesting party having a contractual or other conflict to receive data from a data provisioning party is disallowed to receive data from said provisioning party. The contractual or other conflict can for example be a contract or other issue between the data requesting party and a third party or applicable to the data requesting party, wherein the data providing party is included as a blocked party.

A business relation governance rules can be or imply a rule that ensures that data provided from a data provisioning party having a contractual or other conflict to provide or deliver data to a blocked possible data requesting party are disallowed to be provided to said blocked possible data requesting party. The contractual or other conflict can for example be a contract or other issue between the data providing party and a third party or applicable to the data providing party, in which the data requesting party is included as a blocked party.

A party can for example be blocked due to contract or due to law or court action.

According to some embodiments of the profile provisioning platform, at one of the at least one profile provider interfaces, said exchange of data includes:
to provide profile data to the database, particularly provide an ICCID of a profile or/and an EID of a chip to the database, or/and
to provide profiles to the profile database.

Herein, the profile provider acts as a donor or profile data or/and donor of profiles.

According to some embodiments of the profile provisioning platform, at any one of the at least one profile provider interfaces or/and the at least one-use case owner interfaces, said exchange of data includes:
to provide a profile order or a UICC order to the profile database, wherein the profile order can include profile data, particularly an ICCID of a profile or/and an EID of a UICC, or/and
to retrieve profile data from the database, particularly retrieve an ICCID of a profile or/and an EID of a UICC from the database.

Herein, the profile provider or the use case owner inputs or retrieves profile information or/and UICC information, for example in preparation of a profile download to a UICC.

According to some embodiments of the profile provisioning platform, at one of the at least one UICC requester interfaces, said exchange of data includes:
to provide a UICC request to the database, or/and
to provide metadata or other formal information on a UICC to the database,
to provide an EIS of a UICC to the database.

Herein, the UICC requester provides UICC information, for example in preparation of a profile download to a UICC.

According to some embodiments of the profile provisioning platform, referring to the interfaces:
at least one profile provider interface is provided as an interface ES4 or ES2 according to GSMA SGP.02 or SGP.22; and/or
at least one UICC requester interface is provided by a proprietary interface USAPI; and/or
at least one-use case owner interface is provided by a proprietary interface USAPI.

Currently, the profile providers or MNOs are allowed to use the SGP.02 ES2 or ES4 interface, and use case owners and UICC requester are not allowed to use the SGP.02 ES2 or ES4 interface, and instead make use of a proprietary USAPI interface. Provided it is allowed, alternatively, the use case owners or/and UICC requester may make use of an SGP.02 ES2 or ES4 interface.

According to some embodiments of the invention, the proprietary interface USAPI, Universal API, Universal Application Programming Interface, provides at least a functionality allowing to an owner of the interface a delegation to a partner, such that the interface owner and one or several partners (delegates) can each use the interface.

According to embodiments of the invention, the proprietary interface USAPI is a JSON based Representational State Transfer, REST, interface.

According to some embodiments, the profile provisioning platform comprises one or several of the following elements, in similarity to the SGP.02 architecture:
a data generation instance allowing two or more different profile providers to input profile data for data generation, i.e. the generation of a profile in a format of personalization data directed to installing a profile in a UICC;
a data preparation server allowing two or more different profile providers to input profile data for data preparation, i.e. the preparation of the readily generated profile for transport and download to the UICC, which can particularly include the generation of a profile package which can include the profile in form of personalization data;
a secure router allowing two or more UICC requesters to request profiles and receive profiles, wherein the profiles may be contained in profile packages.

At least one of the three roles (role profile provider, role use case owner, role UICC requester) is occupied by two or more different role holders. This can be achieved in that at least one of the above three instances (data generation instance, data preparation server, secure router) allow two or more role holders to access. Further of the three instances can be implemented also to allow two or more accessors, or only one accessor.

According to some embodiments, data provisioned to the profile provisioning platform with the above-described architecture are stored to the data generation instance or the data preparation server.

According to some embodiments, data output from the profile provisioning platform with the above-described architecture in reply to a request for data are output from the secure router.

According to some embodiments, requests for data received at the profile provisioning platform with the above-described architecture are physically received at the secure router.

On a logical level, the business relation manager ensures that when storing data also access rules for said data are stored and implemented. The business relation manager also ensures on a logical level, that when data are requested to be output, the stored and implemented access rules are followed.

Preferably, the profile provisioning platform further comprises an access control layer manager managing physical access of profile providers, use case owners and UICC requesters to the profile provisioning platform.

The access control layer, managed by the access control layer manager, enables physical access of profile providers, use case owners and UICC requesters to the profile provisioning platform. The access control layer can be or comprise one or several of the following:
an Application Programing Interface, API;
a Graphical User Interface, GUI;
a file exchange interface constructed to exchange files, particularly receive batch files including a batch of several commands to be executed by the profile provisioning platform or by a UICC in communication with the profile provisioning platform.

According to some embodiments, the access rules include that access to data is allowed to an owner of the data and to partners, if any, of the owner of the data. The owner of the data is for example a party provisioning data and data access rules to the profile provisioning platform, for storing the data to the profile database, and implementing the access rules to the business relation manager. The partner can for example be a party having interest to request, in the future, download of profiles generated with the data. According to some embodiments, the access rules include a Whitelist of partners, and/or of partners of partners, for which access to data is allowed.

According to some embodiments, an identifier of the owner of the data and identifiers of the partners are stored in data information fields related to the data.

According to some embodiments, an identifier of a partner is stored in a data information field related to a delegate of the owner of the data.

According to some embodiments, the profile provisioning platform further is characterized in that: the profile database allows access by at least two different profile providers or/and at least two different use case owners or/and at least two different UICC requesters.

The data related to a profile for a UICC is or comprises, according to embodiments of the invention, either one or several of:
profile data required to generate a profile—herein can be included at least the International Mobile Subscriber Identity IMSI, the Authentication key Ki, and the profile number ICCID;
one or several profiles;
one or several eUICC Information Sets, EISs, or one or several sets of metadata related to an UICC, particularly metadata similar to an EIS.

The profile data required to generate a profile, the profiles, and the EIS or similar metadata, are, by means of the access rules managed by the business relation manager, accessible by the owner of the data, and in addition by further parties. The further parties can, for example, be partners or delegates, as stored in the owner data field or partner/delegate data field of the profile, or in the owner data field or partner/delegate data field of the EIS.

A method for provisioning data to a profile provisioning platform according to the invention presented herein comprises the steps:
at one or several interfaces, selected from the profile provider interface, the use case owner interface and the UICC requester interface, receive data and access rules related to the data;
store the received data to the profile database;
implement the received access rules to the business relation manager.

Irrespective of if a profile provisioning platform used by only one party or several parties, also general security measures are recommendable to secure the profile provisioning platform against abusive intrusion or access.

In the presently provided profile provisioning platform allowing several parties to access the profile provisioning platform, the business relation manager ensures secure management of data in the profile provisioning platform. The several parties can be the three role holders, or in an extended version in addition multiple holders of the same role.

By the method according to the present invention, a party which can be a profile provider, e.g. an MNO or MVNO, a use case owner which can be an OEM like a carmaker or industrial device maker or smartphone maker, or a UICC requester who can be an Automotive or M2M mobile device maker or a UICC manufacturer, can provide data to the database, and prescribe by access rules, which party or parties are allowed to access the provided data later. For example, a party providing data to the database can prescribe that itself and some further defined parties are allowed to access the data, and which parties are disallowed to access the data.

According to some embodiments, the data provisioned to the profile provisioning platform are or comprise profile data and are provided to the profile provisioning platform at a profile provider interface.

In this case, the access rules effect that, when a party requests delivery of a profile via the UICC requester interface, only parties allowed to access the data are able to request a profile from the profile provisioning platform, and afterwards get delivered a profile that was generated making use of those particular profile data. A party not allowed to access the profile data might have allowance to request delivery of a profile to its UICC, and get delivered a profile to its UICC, however the profile then has to be generated excluding the particular profile data, however making use only of other profile data, for which the data providing party set no restrictions against this particular requesting party, or allowed the requesting party to access the profile data.

A method for operating a profile provisioning platform according to the invention presented herein comprises the steps:
at an interface, selected from the profile provider interface, the use case owner interface and the UICC requester interface, receive from a requesting party, being a profile provider, a use case owner or a UICC requester, a request for data to be output from the profile provisioning platform to a specified output interface;
at the business relation manager, verify the access rules, and output the requested data only under the condition the access rules allow providing the requested data to the specified output interface.

According to some embodiments, the specified output interface, at which the data are requested to be output, is implicitly specified in that it is the same interface at which the request for data output is received. For example, a UICC requester can request at the UICC request interface that a profile shall be provided to its UICC via the UICC requester interface. In other words, a party can at an interface request a profile for itself.

According to some embodiments, the specified output interface, at which the data are requested to be output, is explicitly specified as a particular interface, which can be either the interface at which the request is received, or a different interface. In other words, a party can at an interface request a profile on behalf of another party which communicates with the profile provisioning platform via a different interface.

According to some embodiments, the request for data is a profile order, and the requested data is or comprises a profile to be provided to a target UICC.

A specified output interface to which the profile shall be output is preferably an interface to the target UICC, for example an SGP.02 ES5 interface.

The role of a profile provider which provides profile data can be filled for example by: a Mobile Network Operator, MNO; a virtual Mobile Network Operator, MVNO.

The role of a use case owner can be filled for example by: a Service Provider like for example a carmaker like BMW, Audi, Volvo, . . . ; or a provider of a Smart Industrial or Smart Home Architecture; or a Smartphone maker like Apple, Samsung, . . . ; or a UICC requester.

The role of a UICC requester can be filled for example by: an Automotive device maker like Bosch, Continental, . . . ; a Smart Industrial or Smart Home mobile device maker; a UICC manufacturer or chipmaker.

### BRIEF DESCRIPTION OF THE DRAWINGS

Embodiments of the invention will now be described with reference to the accompanying drawings, throughout which like parts are referred to by like references, and in which represents:

FIG. 1 a profile provisioning platform according to an embodiment of the invention;

FIG. 2 a setup of four profile provisioning platforms, according to the prior art.

### DETAILED DESCRIPTION OF THE INVENTION

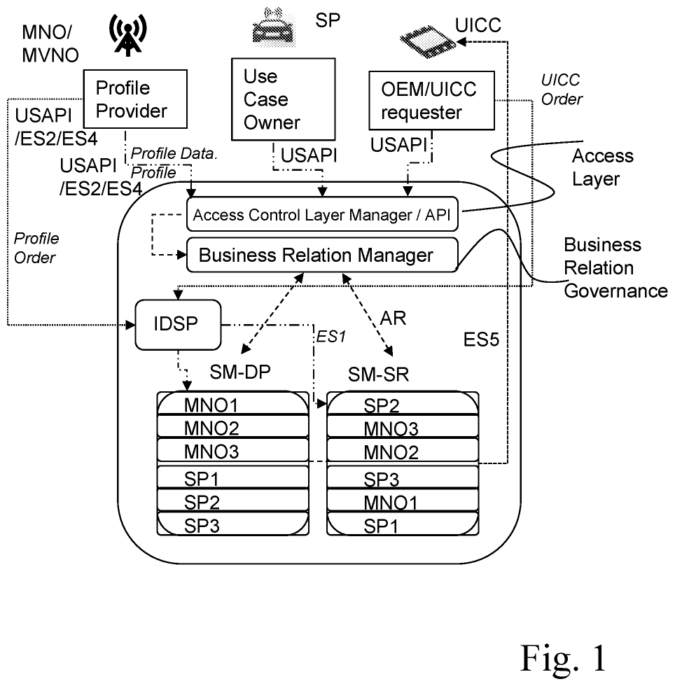

FIG. 1 shows a profile provisioning platform PP according to an embodiment of the invention. The profile provisioning platform PP includes a profile database structured into a data generation IDSP, a data preparation SM-DP and a secure router SM-SR. The underlying structure of the exemplary database and its interfaces of FIG. 1, from which the present invention starts as a basis, are similar to the architecture of SGP.02. Other structures of the profile database and the interfaces are also suitable for applying the invention. The profile database stores data required to prepare profiles or/and profiles. The profile provisioning platform PP further comprises: at least one profile provider interface, which can be an ES2, ES4 or proprietary USAPI interface, allowing a profile provider to provide or input (donate) profile data or/and profiles to the profile database. At a further interface, which can be an ES2, ES4 or proprietary USAPI interface, a profile provider can send a profile order (request for a profile for a UICC) and/or information on an ordered profile, like profile number ICCID or chip identifier EID of a target UICC to the profile database. The profile provisioning platform PP further comprises: at least one use case owner interface, which is a proprietary USAPI interface, allowing a use case owner to send profile orders and/or information on an ordered profile, like profile number ICCID or chip identifier EID of a target UICC, to the profile database. The profile provisioning platform PP further comprises: at least one UICC requester interface, which is a proprietary USAPI interface, allowing a UICC requester to order a UICC, and send UICC information like an EIS or other metadata on a UICC to the profile database. The profile database of FIG. 1 allows access by at least two different profile providers or/and at least two different use case owners or/and at least two different UICC requesters. Herein, a business relation manager manages access of the different profile providers, use case owners and UICC requesters to data in the profile database. To achieve the managing, the business relation manager applies a set of access rules, allowing profile owners and partners or delegates of profile owners provided in the profile database to access the database according to the access rules. The access rules that the business relation manager applies may also imply business relation governance rules so as to allow or disallow access of certain profile providers, use case owners and UICC requesters to data in the profile database, particularly access to data provided by a party, namely profile provider, use case owner or UICC requester, different from the accessing party, namely profile provider, use case owner or UICC requester. An access layer manager, which can be implemented as an Application Programming Interface, API, manages physical access of profile providers, use case owners and UICC requesters to the profile provisioning platform.

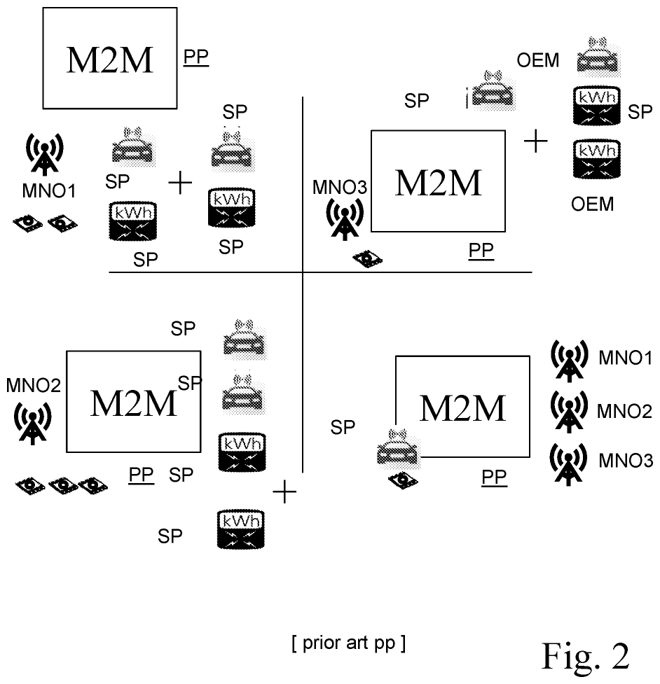

FIG. 2 shows a setup of four profile provisioning platform PP, according to the prior art. Each of the four profile provisioning platform PP is dedicated to a particular combination of MNOs and service providers, SPs. The SPs can be for example car manufacturers, shown by a car, or industrial or smart home M2M service providers, SPs, shown by a kwh meter. In the setup of FIG. 2, three of the profile provisioning platforms PP are dedicated to only one MNO, MNO1, MNO2, MNO3, respectively, and to several SPs. The fourth profile provisioning platforms PP is dedicated to three MNOs, MNO1, MNO2, MNO3, and to only one SP. A setup combining several MNOs and several SPs is not foreseen in the prior art.

Comparing FIG. 2 to FIG. 1, it is visible that the present invention contributes to reduce the complexity and number of required resource elements of a profile provisioning solution including multiple parties for each of the roles of a profile provider, use case owner and UICC requester. Thus, the risk of failures upon operation and maintenance is reduced, the effort and complexity for onboarding new parties to the profile provisioning solution is reduced. In consequence costs and time-to-market for setting up the profile provisioning platform as well as for onboarding (adding) new parties as new participants are reduced.

An exemplary implementation of access rules makes use of data information fields related to the data in which an owner of the data and a partner of the owner of the data are stored. For example, in data related to a profile of a UICC, which are embodied as a profile, the profile itself can comprise a data information field “Owner” which can be used to store an owner of the data, and a data information field “Partner” which can be used to store and a partner of the owner of the data, as follows:
Profile:
Owner=<mno-custid> e.g. MNO-Company-X
Partner=<oem-custid> e.g. Carmaker-Y

In this example, the profile is owned by the MNO-Company-X, and the identifier “mno-custid” of MNO-Company-X is stored in the owner field of the profile information data of the profile. The owner MNO-Company-X has a partner Carmaker-Y, who is a carmaker and use case owner. Correspondingly, in a data field “Partner” of the profile information data of the profile, the identifier “oem-custid” of Carmaker-Y is stored.

According to a further example, access rules imply an owner of a profile, a partner of a profile owner, as above, and in addition a Whitelist of partners of partners. According to the further example, the data related to a profile of a UICC are embodied as an eUICC Information Set, EIS. The UICC is herein embodied as an eUICC. The owner, partner and Whitelist are stored in the EIS.
eUICC EIS:
Owner=<oem-custid> e.g. MNO-Company-X
Partner=<partner-oem-custid> e.g. Carmaker-Y
MNO_DP_Whitelist=<mno-dp-custids-csv> e.g., MNO-Company-A/UICC-provider-U; or MNO-Company-B/UICC-provider-V.

In this example, Carmaker-Y might want to have not only MNO-Company-X who is the owner of the profile, but in addition a different MNO, namely MNO-Company-A to provide connectivity. Accordingly, by the Whitelist, Carmaker-Y is allowed to allow MNO-Company-A to use the profile data provided by MNO-Company-X to generate a profile to be used with the network of MNO-Company-A as the home network, even though MNO-Company-A is not the owner of the profile data. In addition, a UICC-provider-U is allowed to be involved by Carmaker-Y.

Similarly, Carmaker-Y is allowed to use the profile data owned by MNO-Company-X for a use case involving an MNO-Company-B and a UICC-provider-V, which are to MNO-Company-X partners of its partner Carmaker-Y.

Further, the two above shown examples of a profile and an eUICC EIS can be combined with each other. The profile is owned by the MNO-Company-X, and the eUICC to which the profile shall be installed is owned by the Carmaker-Y. The MNO-Company-X lists in the profile itself as the owner and the Carmaker-Y as a partner. The owner-ID of the owner (MNO-Company-X) can be stored in an owner data field of the metadata of the profile, and the ID of the partner (Carmaker-Y) can be stored in a delegate-of-owner data field of the metadata of the profile.

In the EIS of the eUICC, the situation is the other way round as compared to the profile. In the EIS, the Carmaker-Y stores itself as the owner, and the MNO-Company-X as a partner. Also here, the owner-ID of the owner (Carmaker-Y) can be stored in an owner data field of the metadata of the EIS, and the ID of the partner (MNO-Company-X) can be stored in a delegate-of-owner data field of the metadata of the EIS.

When the MNO-Company-X or the Carmaker-Y seeks access to the profile or the EIS stored in the profile provisioning platform, it provides its identifier. The provided identifier is com-pared to an identifier stored in the owner and partner/delegate fields in the metadata of the profile or EIS. It is identified that the accessing MNO-Company-X or the Carmaker-Y is stored as owner or partner/delegate, and access to the profile or EIS is granted. In case a different MNO or Carmaker, with which no agreement exists, tries to access the profile or EIS, and provides its identifier, and the provided identifier is not found as stored in the metadata of the profile or EIS, neither in the owner data field, nor in a partner data field of the metadata, the access for the different MNO or Carmaker is denied.

1. A profile provisioning platform comprising:
a profile database storing data related to a profile for an UICC;
at least one profile provider interface allowing a profile provider to exchange data with the profile database;
at least one use case owner interface allowing a use case owner to exchange data with the profile database;
at least one UICC requester interface allowing a UICC requester to exchange data with the profile database, said exchange including at least to request profiles or/and receive profiles from the profile database;
wherein a business relation manager managing access of the different profile providers, use case owners and UICC requesters to data in the profile database based on access rules related to the data.

2. The profile provisioning platform according to claim 1, wherein the profile database allows access by at least two different profile providers or/and at least two different use case owners or/and at least two different UICC requesters.

3. The profile provisioning platform according to claim 1, wherein the business relation manager applies, as included in the access rules, a set of business relation governance rules so as to allow or disallow access of certain profile providers, use case owners and UICC requesters to data in the profile database, including access to data provided by a party, use case owner or UICC requester, different from the accessing party, use case owner or UTCC requester.

4. The profile provisioning platform according to claim 1, wherein, at the interfaces:
at one of the at least one profile provider interfaces, said exchange of data includes:
to provide profile data to the database, including providing an ICCID of a profile or/and a EID of a chip to the database, or/and
to provide profiles to the profile database; or/and
at any one of the at least one profile provider interfaces or/and the at least one use case owner interfaces, said exchange of data includes:
to provide a profile order or a UICC order to the profile database, wherein the profile order includes profile data, including an ICCID of a profile or/and an EID of a UICC, or/and
to retrieve profile data from the database, particularly retrieve an ICCID of a profile or/and an EID of a UICC from the database;
at one of the at least one UICC requester interfaces, said exchange of data includes:
to provide a UICC request to the database, or/and
to provide metadata or other formal information on a UICC to the database,
to provide an EIS of a UICC to the database.

5. The profile provisioning platform according to claim 1, wherein:
at least one profile provider interface is provided as an interface ES4 or ES2 according to GSMA SGP.02; and/or
at least one UICC requester interface is provided by a proprietary interface USAPI; and/or
at least one use case owner interface is provided by a proprietary interface USAPI.

6. The profile provisioning platform according to claim 1, comprising one or several of the following elements:
a data generation instance allowing two or more different profile providers to input data related to profile for a UICC for data generation;
a data preparation server allowing two or more different profile providers to input profile data for data preparation;
a secure router allowing two or more UICC requesters to request profiles and receive profiles.

7. The profile provisioning platform according to claim 1, further comprising an access control layer manager managing physical access of profile providers, use case owners and UICC requesters to the profile provisioning platform.

8. The profile provisioning platform according to claim 1, wherein the access rules include any one or several of the following:
one or several rules that access to data is allowed to an owner of the data and to partners or delegates, if any, of the owner of the data;
a Whitelist of partners, and/or of partners of partners, for which access to data is allowed.

9. The profile provisioning platform according to claim 8, wherein an identifier of the owner of the data and identifiers of the partners are stored in data information fields related to the data.

10. The profile provisioning platform according to claim 1, wherein the data related to a profile for a UICC is or comprises either one or several of:
profile data required to generate a profile, and including at least IMSI, Ki, ICCID;
one or several profiles;
one or several eUICC Information Sets, EISs, or one or several sets of metadata related to an UICC, including metadata similar to an EIS.

11. A method for provisioning data to a profile provisioning platform according to claim 1, comprising the steps:
at one or several interfaces, selected from the profile provider interface, the use case owner interface and the UICC requester interface, receive data related to a profile for a UICC and access rules related to the data;
store the received data to the profile database;
implement the received access rules to the business relation manager.

12. The method according to claim 11, wherein the data related to a profile for a UICC is or comprises either one or several of:
profile data required to generate a profile, and including at least IMSI, Ki, ICCID;
one or several profiles;
one or several eUICC Information Sets, EISs, or one or several sets of metadata related to an UICC, particularly metadata similar to an EIS.

13. A method for operating a profile provisioning platform according to claim 1, comprising the steps:
at an interface, selected from the profile provider interface, the use case owner interface and the UICC requester interface, receive from a requesting party, being a profile provider, a use case owner or a UICC requester, a request for data to be output from the profile provisioning platform to a specified output interface;
at the business relation manager, verify the access rules, and output the requested data only under the condition the access rules allow providing the requested data to the specified output interface.

14. The method according to claim 13, wherein the specified output interface is:
implicitly specified in that it is the interface at which the request is received; or
explicitly specified as a particular interface, including the interface at which the request is received or a different interface.

15. The method according to claim 13, wherein the request for data is a profile order, the requested data is or comprises a profile to be provided to a target UICC.
